(19) United States
(12) Patent Application Publication
(10) Pub. No.: US 2004/0069206 A1
(43) Pub. Date: Apr. 15, 2004

(54) Removable bookmarker

(76) Inventor: Kyomasa Uehara, Naha-shi (JP)

Correspondence Address: MURAMATSU & ASSOCIATES, Suite 225, 7700 Irvine Center Drive, Irvine, CA, 92618, US

(21) Appl. No.: 10/269,684

(22) Filed: Oct. 12, 2002

(51) Int. Cl. B42D 9/00

(52) U.S. Cl. 116/237

(57) ABSTRACT

A removable bookmarker for marking positions or pages of a book. The bookmarker having a plurality of bookmarker strings is freely removable from the book. The removable bookmarker is composed of an attachment member such as a hairpin clip or a gem clip and a plurality of bookmarker strings connected to a top of the attachment member. An end of the attachment member is slid onto a front cover or a spine of the book so that the bookmarker strings are mounted on the book.

### FIELD OF THE INVENTION

This invention relates to a bookmarker for marking positions or pages of a book, and more particularly, to a bookmarker or bookmarker strings that are freely removable from the book.

### BACKGROUND OF THE INVENTION

A typical conventional bookmarker is comprised of one or two strings that are attached to the inner side of the book spine. The conventional bookmarker strings are fixedly attached to the top of the book spine, which is not convenient, however, when the number of strings is insufficient. Although only a few strings are needed for reading a book such as a fiction, one or two strings are usually not enough for reading other types of book such as a science encyclopedia, legal handbook, dictionary, collection of works, or the like.

Some books do not even have bookmarker strings. In such cases, a reader has to use separate pieces of paper such as memopads or stickers to satisfy his needs. However, this is inconvenient because it is necessary to prepare or find separate pieces of paper or memopads, which is bothersome for a reader. Further, the reader will be interrupted what he is doing in order to find such bookmarkers.

Further, because such bookmarkers are not a part of the book, they can easily fall out or fly away, which defeats the purpose in the end.

### SUMMARY OF THE INVENTION

It is, therefore, an object of the present invention to solve such problems and to provide a removable bookmarker with a relatively large number of strings for use with a book having a small number of bookmarker strings or no bookmarker strings at all.

The above object of the present invention is achieved by the following structure of the bookmarker. The first aspect is a removable bookmarker, where one or more strings are attached at the top of a hairpin clip, and an end of the hairpin clip is slid onto the front cover or the spine of the book to attach the bookmarker strings to the book.

As a result, a separate bookmarker with multiple strings can be used when the book has an insufficient number of strings or no strings at all. Such bookmarker strings can also be used when organizing a plurality of filed documents or when needing to mark a plurality of documents, thereby improving work efficiency.

The second aspect is a removable bookmarker as in the first aspect where a tightening portion (clamp) is formed at an end of the hairpin clip for connecting one or more bookmarker strings. As a result, the attached end of the bookmarker strings will not easily slip away from the clamp, thereby preventing the strings from shifting from the top as well as through the clamp.

The third aspect is a removable bookmarker in which one or more strings are attached at the top of a gem clip, and the end of the gem clip is slid onto the front cover or the spine of the book to attach the bookmarker strings to the book. This structure is convenient when the book has an insufficient number of strings or no strings at all, as well as when organizing a multiple number of filed documents or when it is necessary to mark a multiple number of documents as explained above with respect to the hairpin clip.

The fourth aspect is a removable bookmarker having the gem clip noted above in which a clamp (tightening portion) for connecting one or more strings is formed at the top of the gem clip. This structure is effective in preventing the bookmarker strings from slipping away from the gem clip.

The fifth aspect is a removable bookmarker applicable to all of the foregoing embodiments where a T-shaped unit attached to or formed on the string is inserted in the hole on an oblong card. In this arrangement, the oblong card can be used for writing down notes, memo, etc. This structure allows the bookmarker string and the oblong card to be combined as one, which is convenient for the user. When the user no longer needs his notes, he can throw away the oblong card or save it elsewhere, then attach a blank oblong card to be used for other purposes.

The sixth aspect is a removable bookmarker, where one or more strings are detachably connected at the top of an attachment clip such as the hairpin clip or gem clip. As a result, additional bookmarker strings can be attached to the attachment clip when the user so desires. In other words, this set of strings is separable from the hairpin clip or gem clip.

The seventh aspect is a method of using the removable bookmarker having a plurality of strings where one or two strings are twice as long as the other strings and tied to the top of the attachment clip. As a result, the bookmarker string or strings will be directly attached to the attachment clip, and the remaining portion can be used as an extra bookmarker string or strings in addition to the other strings. Hence, the application of the strings is not limited to the bookmarker but also to the attachment means.

The eighth aspect is a structure of the bookmarker strings, where one string is longer than the rest and its center is marked to be connected to the attaching clip. As a result, the center of this long bookmarker string can be easily identified when connecting to the attachment clip. Also, this long bookmarker string can be used as two bookmarker strings once the center is attached to the attachment clip.

### BRIEF DESCRIPTION OF THE DRAWINGS

FIGS. 1A-1C are schematic diagrams showing the structure of the removable bookmarker of the present invention using a hairpin clip.

FIGS. 2A and 2B are schematic diagrams showing the structure of the removable bookmarker of the present invention where a set of bookmarker strings has a ring for connection with the hairpin clip.

FIGS. 3A-3E are schematic diagrams showing the bookmarker of FIG. 2 where the set of bookmarker strings has an attachment string instead of the ring. FIG. 3A shows the condition before the strings are attached, FIG. 3B shows the condition where the strings are attached to the clip, FIG. 3C shows the condition where two bookmarker strings are used as the attachment strings, FIG. 3D shows the condition where one bookmarker string twice as long as the regular string is marked at the center, and FIG. 3E shows the condition where the one long string in FIG. 3D is attached to the clip.

FIGS. 4A-4G are schematic diagrams showing the structure of the bookmarker of the present invention in which the hairpin clip has a tightening portion (clamp). FIG. 4A shows an enlarged view of a tightening ring, FIGS. 4B and 4C show side views of a twofold structure of the tightening portion, FIG. 4D shows a way of attaching the bookmarker strings to the tightening ring, FIGS. 4E-4G are side views showing further examples of the tightening portion.

FIGS. 5A and 5B are schematic diagrams showing the removable bookmaker of the present invention in which the hairpin clip is configured to hold a note pad. FIG. 5A shows a hairpin clip having a straight shape, and FIG. 5B shows a hairpin clip having a wavy shape.

FIGS. 6A and 6B are schematic diagrams showing the removable bookmaker of the present invention using a gem clip where FIG. 6A is a front view thereof and FIG. 6B shows the side view thereof.

FIGS. 7A and 7B are schematic diagrams showing the removable bookmaker of the present invention wherein the gem clip has a ring for attaching the set of bookmarker strings. FIG. 7A shows an example of a twisted ring, and FIG. 7B shows an example of a double ring.

FIG. 8 is a schematic diagram showing the removable bookmaker of the present invention wherein a piece of paper is attached to the end of each bookmarker string.

### DETAILED DESCRIPTION OF THE INVENTION

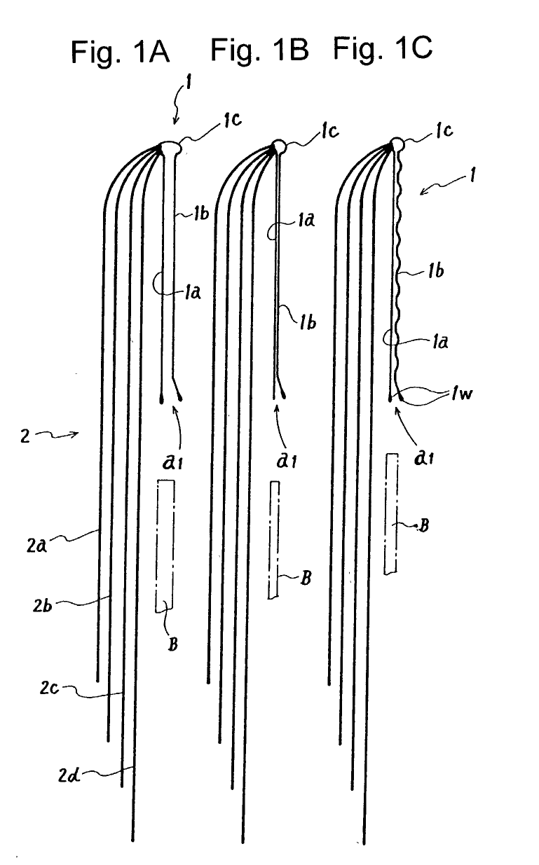

The removable bookmarker of the present invention will now be described in more detail with reference to the accompanying drawings. FIG. 1 shows an embodiment of the bookmarker of the present invention using a hairpin clip. Reference numeral 1 denotes the hairpin clip, which is composed of two parallel clasp bars 1a and 1b having a U-shaped top 1c.

Reference numeral 2 denotes a set of bookmarker strings (also referred to as “bookmarker strings unit”). In this example, there are 4 bookmarker strings 2a-2d in one unit, where the ends (base) thereof are attached to the U-shaped top 1c of the hairpin clip 1.

Each bookmarker string is shaped like a ribbon with a width of 2 mm-4 mm for example, however, wider bookmarker strings can be used for a larger book. The ends (base) of the bookmarker strings are preferably combined as one and adhered together.

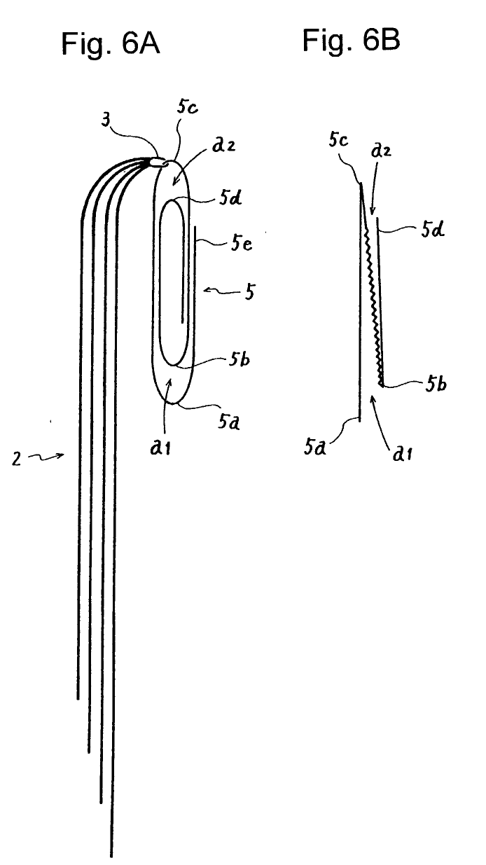

The set of bookmarker strings 2 is attached to the top 1c or 5c (FIG. 6) by an adhesive or in a detachable manner as described later. If detachable, a hole will be created either at the adhered end of the bookmarker strings mentioned above or at the center of a long bookmarker string (twice as long as a regular string). Then, the hole at the end or the center where one of the clasp bars 1a or 1b is inserted therein until the hole reaches the top 1c.

In the structure and method of the bookmarker strings mentioned above or below, only one string can be sufficient for forming the set of bookmarker strings. Each string is made of knitted thread as in regular bookmarker strings, or synthetic resin with a flat shape. It can also be made of non-woven fabric with a flat shape.

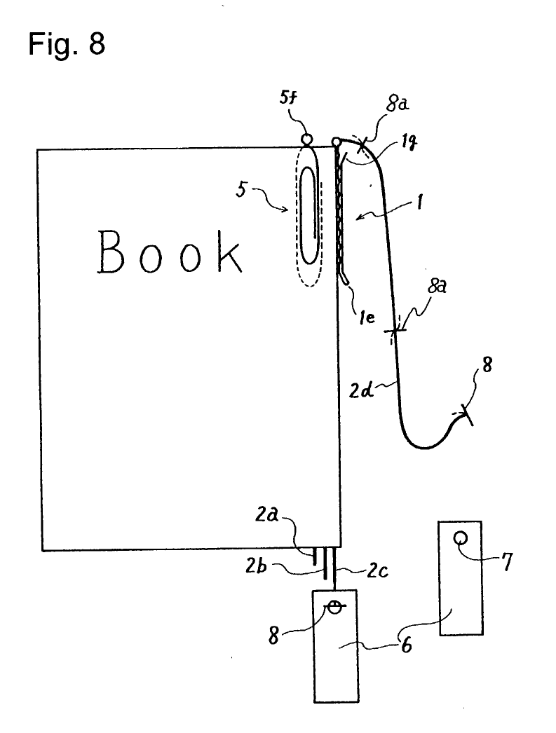

When using the removable bookmarker of the present invention, a portion B such as a front cover, back cover, or spine of the book is inserted through the end of the hairpin clip, i.e., between the two clasp bars 1a and 1b, toward the direction a1. This will enable the clasp bars to clamp the cover or spine of the book, thereby securely attaching the bookmarker as shown in FIG. 8.

Hence, the four bookmarker strings 2a-2d that are now attached to the book or file can be individually inserted between the intended pages even if the original book or file has no strings at all, allowing the user to mark four pages in that book or file.

If the four bookmarker strings are not enough, a user can insert another removable bookmarker to increase the number of bookmarker strings. Thus, the removable bookmarker of the present invention is convenient when using a large book such as a legal handbook, science encyclopedia, or dictionary, which in turn improves the user's work efficiency. The removable bookmarker is also convenient when students are preparing for examinations for marking pages in reference books and study aids.

Further, the removable bookmarker of the present invention is convenient when using files with multiple pages, where the user can insert the bookmarker strings between the intended pages. For example, the hairpin clip can clamp the front cover or desired page of the file document so that the bookmarker strings 2a-2d can be individually used.

In FIG. 1A, the space between the two clasp bars 1a and 1b of hairpin clip 1 is widened in advance so that it will fit to a thick portion B such as the front cover of a book. In contrast, the space between the two clasp bars 1a and 1b in FIG. 1B is made narrow to fit to a thin portion B of the book. In this manner, several different hairpin clips corresponding to the different thickness of the front cover or the spine of the book can be prepared. However, usually, the one with the smaller space as shown in FIG. 1B can be commonly used for the different thickness of the front covers.

The portion B does not always have to be the front cover of a book. It can also be a set of multiple pages in a book, file, or notebook. Such a set of multiple pages can inserted in the hairpin clip 1 or the gem clip mentioned later toward the direction a1, thereby quickly attaching the bookmaker.

In FIG. 1C, the clasp bar 1b of the hairpin clip 1 has a wavy shape so that it will not easily slip or fall off when attached to the portion B such as a front cover.

In each of the hairpin clips shown in FIGS. 1A-1C, preferably, an opening at the end is widened to easily receive the front cover of a book. Further, if the end of each clasp bar is sharp, it is dangerous to users and may also damage the papers and books. Thus, it is preferable to coat the ends of the clasp bars with, for example, resin in the shape of a water drop 1w.

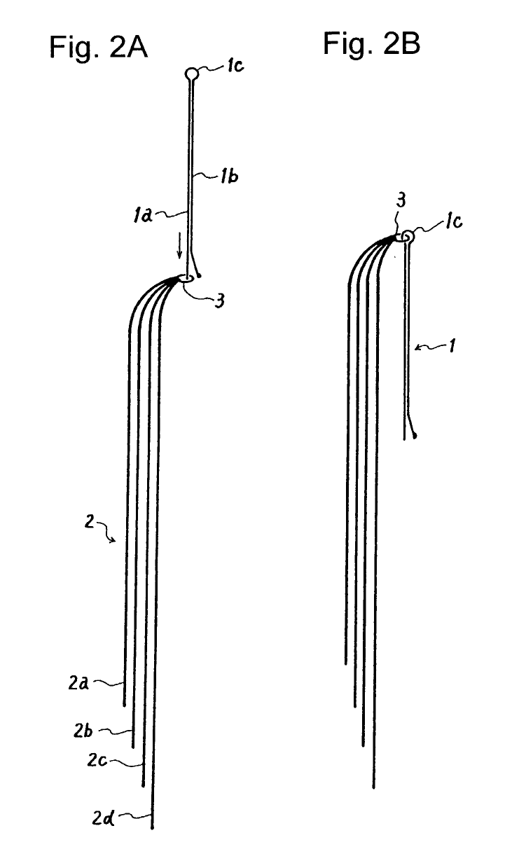

Unlike the adhesives used in FIG. 1, the base of bookmarker string unit 2 of FIGS. 2A-2B is detachably connected to the top of the hairpin clip. Namely, in FIGS. 2A and 2B, the base (end) of each string 2a-2d is connected to a small ring 3.

The material of the ring 3 can be a string, a thread, or fabric, or can be synthetic resin or metal. The manner of attachment between the ring 3 and the base of bookmarker strings 2a-2d vary depending on the type of material used, although the adhesive bond or heat fusion bond is possible. If the ring 3 is a string, thread or fabric, it can be sewn together with the base of the bookmarker strings. Alternatively, a hole can be opened at the base of the strings and the ring 3 is inserted in the hole. This hole can be formed after attaching the base of each bookmarker string together by the adhesive method explained above. In a word, the bookmarker strings and the ring can be attached together by various methods.

As shown in FIG. 2A, one of the clasp bars 1a or 1b of the hairpin clip 1 is inserted in the ring 3 of the bookmarker strings 2a-2d, where the ring 3 is moved upward until it reaches the top 1c as shown in FIG. 2B. By having the ring or hole mentioned above at the base of the bookmarker strings, the bookmarker strings and the hair pin are separately stored and they can be connected to one another only when the bookmarker is necessary. Namely, the bookmarker strings and the hairpin clip are detachable.

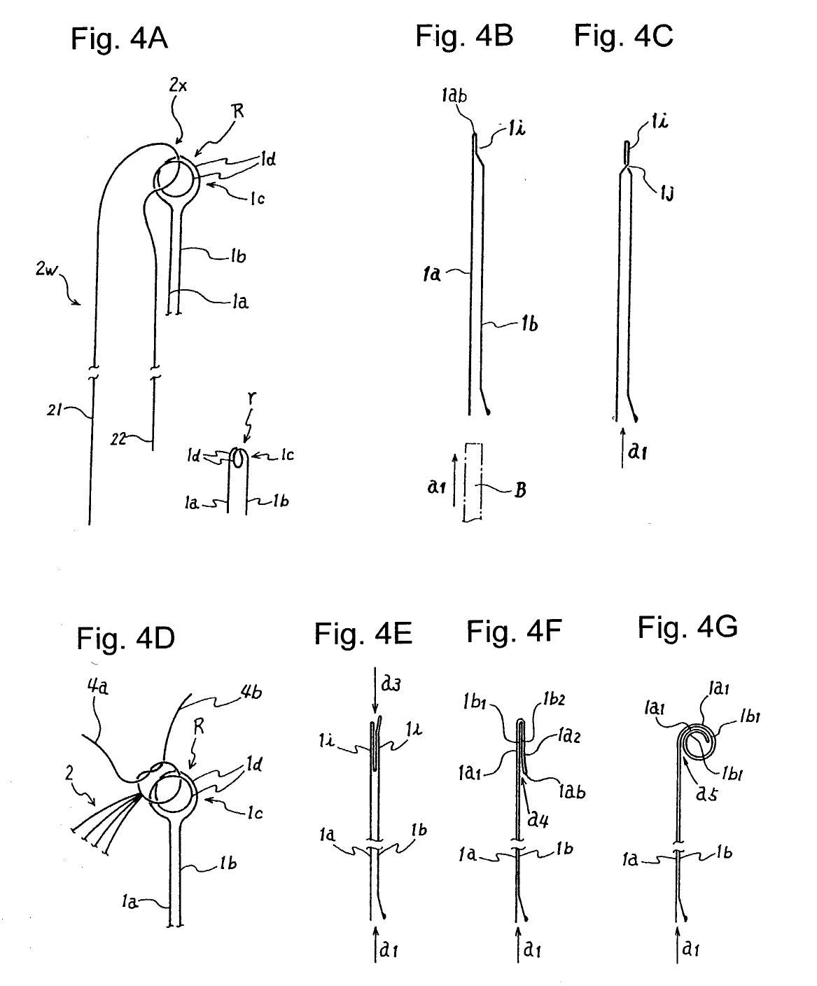

Instead of attaching the several bookmarker strings, only one end of a single string or the center of one long string can be connected to the top of the hairpin clip or the gem clip. Such an end of the string or the center of the string can be attached to the hairpin clip or gem clip by adhering or tying to the top of the clip, inserting in a connecting hole of the clip, or being clamped by the clip as shown in FIGS. 4A-4G.

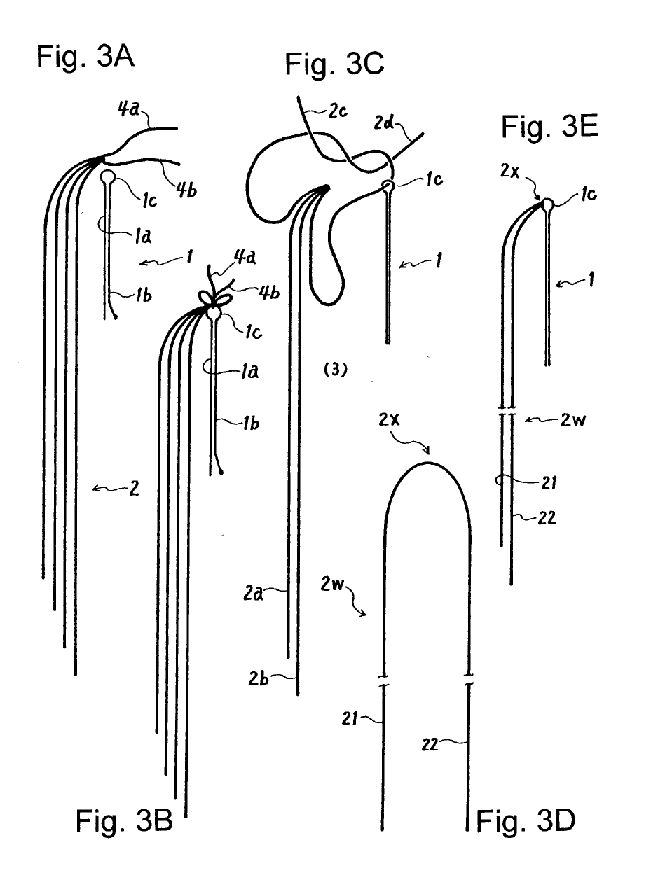

In FIG. 3A, two short threads or strings 4a and 4b are provided at the base of the string unit 2 instead of the ring 3 of FIGS. 2A and 2B. The two short threads or strings 4a and 4b are tied at the top of the hairpin clip or gem clip in a bow as shown in FIG. 3B. Instead of the threads or strings 4a and 4b, ribbons can also be used.

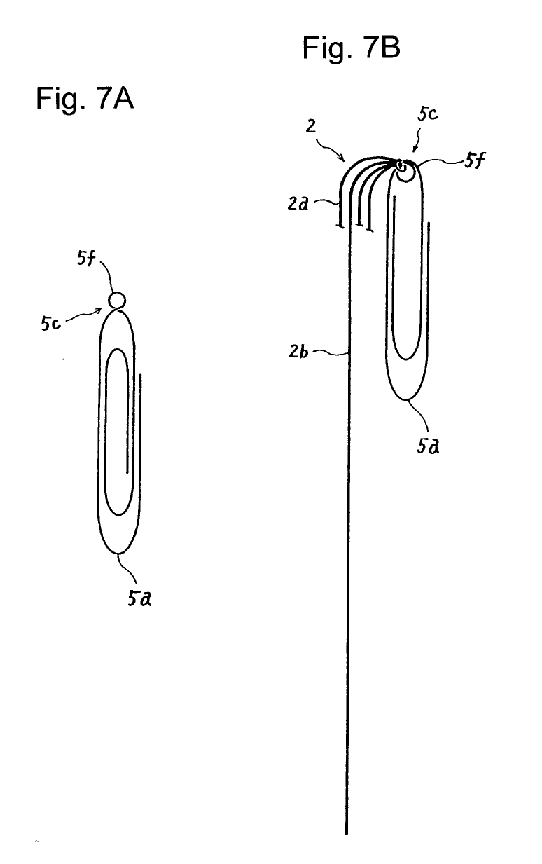

FIG. 3C shows an example where two of the four bookmarker strings 2a-2d are used in place of the strings 4a and 4b of FIG. 3B. In other words, the two bookmarker strings 2c and 2d can be tied to the top 1c of the hairpin clip 1, a top 5c of the gem clip of FIG. 6, a ring R or a twofold unit 1i of FIG. 4, or a ring 5f of FIG. 7.

Further, a single bookmarker string can be used in this example. As shown in FIGS. 3D and 3E, a bookmarker string 2w, which is twice as long as a regular bookmarker string, is used, where it is marked at the center 2x or near the center 2x.

For example, by using the center 2x as a dividing point, one side 21 of the string can be colored in red and the other side 22 in black. Alternatively, the center 2x can be colored. Then, as shown in FIG. 3E, the center 2x or near the center 2x is attached to the top 1c of the hairpin clip 1 in a detachable way.

In other words, the center 2x or near the center 2x of the string 2w can be tied to the to (tip) 1c of the clip, or held between the double ring of FIGS. 4A and 4B, or held between the twofold unit 1i of FIGS. 4B and 4C. Since the center 2x or near the center 2x is connected to the tip of the clip, strings 21 and 22 can be used as two individual bookmarker strings. Also, by adding more single long strings, more bookmarker strings can be created.

When the mark on the long bookmarker string is established slightly off center instead of exact center and the marked point is connected to the tip of the clip, two bookmarker strings 21 and 22 with different lengths can be formed as shown in FIG. 3E.

As described above, by using the bookmarker string 2w having the length which is twice as long as the regular bookmarker string, and connecting its center or near center portion to the top of the hairpin clip by tying or clasping, the remaining portions of the string can be used as bookmarker strings. This idea of forming two bookmarker strings out of one long string can also be applied to the gem clip of FIG. 6.

FIGS. 4A-4G show various examples of tightening portion (clamp) for attaching the bookmarker strings. The top (tip) 1c of the hairpin clip 1 as shown in FIGS. 4A and 4D is formed in a closed ring (tightening portion or clamp), unlike the ring shown in FIGS. 1-3. In order to construct this type of ring, the top 1c is looped twice as a rings R as shown in FIG. 4A. One long bookmarker string 2w is inserted between rings 1d and 1d forming the ring R (double ring). The double ring R does not always have to be large in diameter. Instead, it can be a small ring with a diameter about as the same as the distance between the clasp bars 1a and 1b, like a ring r as shown in lower right of FIG. 4A.

The string unit 2 can be tied to the double ring R (rings 1d and 1d) in the manner shown in FIGS. 3A-3C. However, when the two strings 4a and 4b, as shown in FIG. 4D, are inserted through the rings 1d and 1d and tied to one ring 1d only, the grip becomes stronger due to the spring action between the rings 1d and 1d, securing the connection.

In an actual implementation, the space between the rings 1d and 1d, which forms the double ring R or r, is not open in a manner shown in the diagram, but is rather tightly closed by the spring action.

When connecting the bookmarker strings having the ring 3 as shown in FIG. 2, one of the clasp bars 1a or 1b is inserted in the ring 3. At this point, the ring 3 is shifted up to the top 1c of the hairpin clip, between the rings 1d and 1d of the double ring, where the connection is firmly established. This will prevent the strings from slipping off the ring or falling off from either the clasp bar 1a or 1b. This is because, in addition to the connection by the ring 3, the connecting point of the bookmarker strings is held by the spring force.

Further, since the spring force increases between the clasp bars 1a and 1b by having the double ring, the bookmarker is more securely held on the book when a part of the book is inserted in the clasp bars. Although this example shows a double looped ring, the ring can be looped in any number of times in accordance with the manner of use and needs of the hairpin clip or gem clip.

As shown in FIG. 4B, in order to maintain such a strong grip or hold, a top 1i of the hairpin clip 1 is folded over in a U-shape with a narrow gap, where the bookmarker strings are held therebetween. Namely, the strings are fixed between the twofold part (tightening portion) 1i by it spring force.

When inserting the portion B such as the front cover of a book between the clasp bars 1a and 1b, the twofold unit 1i may open up and deform permanently, weakening the spring force as a result. To overcome such a problem, the twofold unit 1i can be twisted in an X-shape (cross shape) at a border point 1j as shown in FIG. 4C. In this arrangement, the twofold unit 1i will further close when the clasp bars 1a and 1b are opened when inserting the portion B, thereby more securing the bookmarker strings in place.

FIGS. 4E-4G showing examples of other forms of the twofold unit (tightening portion) 1i at the top of the hairpin clip 1. In FIG. 4E, two of the twofold unit 1i are formed adjacent to one another in the shape of letter M at the top of the hairpin clip 1. The bookmarker strings are inserted in the direction a3 between the twofold units 1i and secured therein by the spring force.

It is possible to have the twofold units 1i and 1i in the same length. However, if one of the twofold units 1i is formed slightly longer than the other, the bookmarker strings can be pulled in between the twofold units toward the direction a3 while contacting the longer twofold unit, the bookmarker strings can be easily held between the twofold units 1i. In this arrangement, if the tip of the longer twofold unit 1i is slightly bent outwardly similar to the tip of the clasp bar 1a or 1b, the insertion of the bookmarker strings will be much easier.

Since the bookmarker strings are held between the twofold units 1i, the twofold units 1i should be formed as close together as possible. If they are spaced apart, that space should be minimal. By having such twofold units 1i, the spring force will increase between the clasp bars 1a and 1b, and thus becomes more resilient, which effectively prevents the permanent deformation of the twofold units (tightening portion) when a thick front cover of a book is inserted between the clasp bars.

FIG. 4F shows an example where the twofold unit 1i is extended and the top of which is folded over in a U-shape. As a result of this structure, the extended portions 1a1 and 1b1 as well as the bent portions 1a2 and lb2 on the clasp bars 1a and 1b are positioned close together. Preferably, the tip lab is slightly opened similar to the end of the clasp bars 1a and 1b.

When the bookmarker strings are inserted between the tip 1ab of the twofold unit 1i and the clasp bar 1b in the direction a4, the bookmarker strings can be secured between the extended portions 1b1 and 1b2.

Moreover, when inserting the bookmarker strings between the clasp bars 1a and 1b in the direction a1, the bookmarker strings can be secured between the extended portions 1a1 and 1b1. Alternatively, the bookmarker strings can pass through the extended portions 1a1 and 1b1 and be secured between the bent portions 1a2 and 1b2.

In the example of FIG. 4F, the U-shape of the bent portion is made in the right and left direction of the sheet of the drawing, however, the bent portion can be made in the front and back direction of the drawing sheet. When bending in the front and back direction, by making the base of the bookmarker strings flatly, the bookmarker strings can be easily slide through the U-shaped portion. Also, the bookmarker strings can be held at the U-shaped portion as well as between the extended portions 1a1, 1b1, and the bent portions 1a2 and 1b2.

In the example of FIG. 4G, the twofold unit 1i is extended as well rolled like a coil spring. As a result of this structure, extended portions 1a1, 1b1, 1a1, 1b1 of the clasp bars 1a and 1b are folded alternately with one another because of the coil structure. Further, each extended portion is positioned close together, or is close sufficiently together with a slight gap therebetween.

The bookmarker strings are inserted between the coil spring portion and the clasp bar 1b in the direction a5 and secured therein by the spring force. The user can decide where the bookmarker strings should be inserted and fixed on the coil spring. The bookmarker strings can also be inserted between the clasp bars 1a and 1b in the direction a1 until they reach the extended portions 1a1 and 1b1. Similarly, the user can decided where the bookmarker strings should be inserted and fixed on the extended portions.

The extended portions 1a1 and 1b1 can be coiled in the front and back direction of this drawing sheet rather than the right and left direction. Further, the bookmarker strings can be secured in the direction a5 or between the extended portions of the clasp bars 1a and 1b.

The above configuration of FIGS. 4A-4G can also be applied to the gem clip.

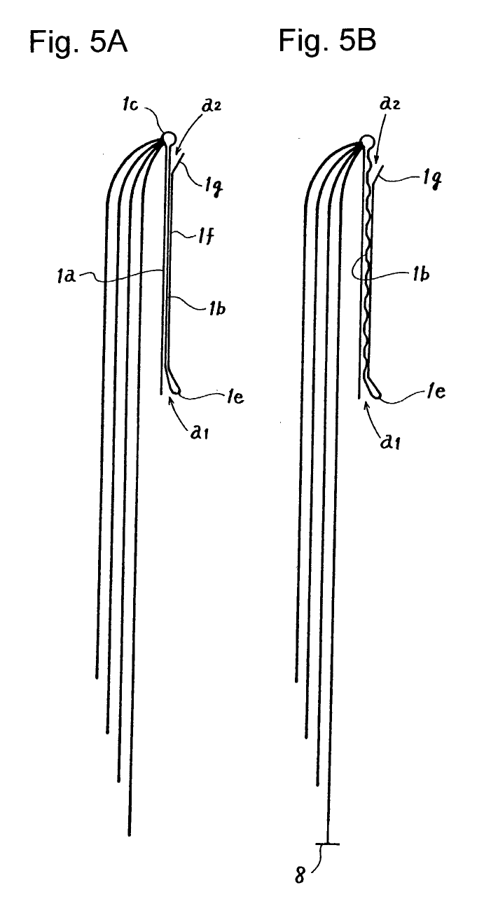

FIG. 5 shows an embodiment which is capable of holding a piece of note per every hairpin clip. In other words, the clasp bar 1b is folded over at an end 1e to form a doubled clasp bar.

Then, a piece of paper such as a business card is inserted at the tip 1g between the third clasp bar if and the tip 1c of the clasp bar 1b in the direction a2. One of the bookmarker strings 2a-2d that is not in use can be used in this case to further stabilize the card or paper.

Unlike the straight clasp bar 1b of FIG. 5A, the clasp bar 1b of FIG. 5B is wavy in shape similar to the one shown in FIG. 1C to make the grip less slippery. Hence, a piece of note inserted between such a structure of the clasp bars will not easily fall out.

The top (tip) 1c of the hairpin clip of FIGS. 5A and 5B can also be formed in a closed ring such as the double ring or cross-shaped ring as shown in FIG. 4.

FIGS. 6A and 6B show an embodiment of the present invention using the gem clip instead of the hairpin clip. The wire of the gem clip in this embodiment is looped twice or more, although a single loop embodiment as seen in regular office supplies can be used as well.

When the gem clip is looped twice or more as shown in the drawing, it can be attached to the book with high stability by inserting the front cover between a large convex part 5a and a small convex part 5b located at the bottom of the gem clip. Also, similar to the case in FIG. 5, a piece of paper can be held between a large convex part 5c and a small convex part 5d located at the top of the gem clip.

As shown in FIG. 6B, by having the wavy part of the gem clip to contact the front cover of a book or a piece of paper, slipping or falling out from the book or paper can be effectively prevented.

In order to connect the bookmarker string unit 2 to the top 5c of the gem clip 5, several strings can be gathered and adhered together and connected to the top 5c. Alternatively, the ring 3 or a hole can be formed at the base of the bookmarker strings as shown in FIG. 2, where the ring 3 goes through the end 5e and shifted around the gem clip 5 until it reaches the top Sc.

As shown in FIGS. 7A and 7B, a ring 5f similar to the one shown in FIG. 4 can be formed where the end of the bookmarker string unit 2 will be attached. In the example of FIG. 7A, the top 5c of the gem clip is twisted in an X-shape, thereby forming the ring 5f. In the example of FIG. 7B, the top 5c of the gem clip is looped twice which forms a double ring 5f similar to the one shown in FIGS. 4A and 4D.

Since the bookmarker string unit 2 can be connected to the ring 5f, the gem clip can secure the strings in place more firmly than a clip without such a ring. Further, since the spring force increases by the ring 5f, the gem clip can be attached firmly to the book.

The top of the gem clip can be constructed in a twofold unit as shown in FIGS. 4B and 4C instead of the ring 5f to stabilize the connection between the top and strings by the spring force of the twofold unit.

As shown in the diagram, although the end of several strings 2a, 2b, . . . are combined as one unit, the length of each string is preferably different. When the lengths of the bookmark strings are different, it is easier to separate and identify one string from the others. However, all of the bookmarker strings can be the same length as well. In addition, providing the strings with different colors can also make the identification easier.

FIG. 8 is an example of the bookmarker where a note can be attached to each bookmarker string. Reference numeral 6 indicates an oblong card such as a flash card where one end of the card has a hole 7. The end or another optional location of a bookmarker string can be tied to the hole 7. Alternatively, as a further convenient way, a method used on clothing price tags, i.e., a T-shaped unit 8 can be attached to the end of the string instead.

In such an arrangement, the T-shaped unit 8 is inserted in the hole 7 on the oblong card 6, allowing the card 6 to hang from the end of the string 2c, which is held between two pages of the book. The T-shaped unit 8 can be established at the center or at the end of the string 2d. Therefore, the T-shaped unit 8 can be established on any location of the bookmarker string. Although this unit is T-shaped when established at the end of the bookmarker string, it will be cross-shaped when established in the center or near the end of the bookmarker string.

If the bookmarker string itself is made of synthetic resin, then, a process of forming the T-shaped unit 8 or the cross-shaped unit 8a will be easy done by forming the strings and T-shaped units at the same time. Alternatively, the T-shaped units 8 can be made separately and attached to the bookmarker strings later through adhesives.

Preferably, the T-shaped unit 8 and cross-shaped unit 8a are slightly bent towards the direction of the bookmarker string to make the insertion in the oblong card or withdrawal from the oblong card easier. As in the foregoing, by allowing the oblong cards 6 to be freely connected to the bookmarker strings, the user can write down notes relating to the content of the pages where the bookmarkers are used.

In the example of FIG. 8, the hairpin clip 1 is attached to the spine of the book, and the gem clip 5 is attached to the front cover of the book.

The material of the hairpin clip and gem clip of the present invention can be synthetic resin, however, metal filaments having a sufficient spring force is more preferable. Further, coating the metal filaments with synthetic resin can prevent rust smudges on the book. Further, the space or gap between the clasp bars 1a and 1b in the foregoing examples can be freely selected depending on the type of books or other objects.

As in the foregoing, in the first aspect of the removable bookmarker, one or more bookmarker strings are attached at the top of the hairpin clip, and the end of the hairpin clip is slid onto the front cover or the spine of the book to attach the bookmarker strings to the book. As a result, a separate bookmarker with multiple strings can be used when the book has an insufficient number of strings or no strings at all. Such bookmarker strings can also be used when organizing a plurality of filed documents or when it is necessary to mark a plurality of documents, thereby improving work efficiency.

In the second aspect of the removable bookmarker, the tightening portion (clamp) is formed at the end of the hairpin clip for connecting one or more bookmarker strings. As a result, the attached end of the bookmarker strings will not easily slip away from the clamp, thereby preventing the strings from shifting from the top as well as through the clamp.

In the third aspect of the removable bookmarker, one or more strings are attached at the top of the gem clip, and the end of the gem clip is slid onto the front cover or the spine of the book to attach the bookmarker strings to the book. This structure is convenient when the book has an insufficient number of strings or no strings at all, as well as when organizing a multiple number of filed documents or when it is necessary to mark a multiple number of documents as explained above with respect to the hairpin clip.

In the fourth aspect of the removable bookmarker having the gem clip, the ring for tightly connecting one or more strings is formed at the top of the gem clip. This structure is effective in preventing the bookmarker strings from slipping away from the gem clip.

In the fifth aspect of the removable bookmarker, the T-shaped unit attached to or formed on the string is inserted in the hole on the oblong card. In this arrangement, the oblong card can be used for writing down notes, memo, etc. This structure allows the bookmarker string and the oblong card to be combined as one, which is convenient for the user. When the user no longer needs his notes, he can throw away the oblong card or save it elsewhere, then attach a blank oblong card to be used for other purposes.

In the sixth aspect of the removable bookmarker, one or more strings are detachably connected at the top of the attachment clip such as the hairpin clip or the gem clip. As a result, additional bookmarker strings can be attached to the attachment clip when the user so desires. In other words, this set of strings is separable from the hairpin clip or gem clip.

In the seventh aspect where a plurality of bookmarker strings are incorporated, one or two strings are twice as long as the other strings and tied to the top of the attachment clip. As a result, the bookmarker string or strings will be directly attached to the attachment clip, and the remaining portion can be used as an extra bookmarker string or strings in addition to the other strings. Hence, the application of the strings is not limited to the bookmarker but also to the attachment means.

In the eighth aspect of the bookmarker strings, one string is longer than the rest and its center is marked to be connected to the attaching clip. As a result, the center of this long bookmarker string can be easily identified when connected to the attachment clip. Also, this long bookmarker string can be used as two bookmarker strings once the center is attached to the attachment clip.

Although only preferred embodiments are specifically illustrated and described herein, it will be appreciated that many modifications and variations of the present invention are possible in light of the above teachings and within the purview of the appended claims without departing the spirit and intended scope of the invention.

What is claimed is:

1. A removable bookmarker for marking a page of a book, comprising:
a hairpin clip; and
at least one bookmarker string connected to a top of the hairpin clip;
wherein an end of the hairpin clip is slid onto a front cover or a spine of the book so that the bookmarker string is mounted on the book.

2. A removable bookmarker as defined in claim 1, wherein a tightening portion is formed at the top of the hairpin clip and at least one bookmarker string is secured by the spring force of the tightening portion.

3. A removable bookmarker as defined in claim 2, wherein the tightening portion is a ring having at least two loops thereby tightening the bookmarker string therein.

4. A removable bookmarker as defined in claim 2, wherein the tightening portion is a twofold unit where wire of the hairpin clip is folded with a sharp curve thereby tightening the bookmarker string therein.

5. A removable bookmarker as defined in claim 2, wherein the tightening portion is a twofold unit where wire of the hairpin clip is folded with a sharp curve and further curved to form a coil spring thereby tightening the bookmarker string therein.

6. A removable bookmarker for marking a page of a book, comprising:
a gem clip; and
at least one bookmarker string connected to a top of the gem clip;
wherein an end of the gem clip is slid onto a front cover or a spine of the book so that the bookmarker string is mounted on the book.

7. A removable bookmarker as defined in claim 6, wherein a tightening portion is formed at the top of the gem clip and at least one bookmarker string is secured by the spring force of the tightening portion.

8. A removable bookmarker as defined in claim 7, wherein the tightening portion is a ring having at least two loops thereby tightening the bookmarker string therein.

9. A removable bookmarker as defined in claim 7, wherein the tightening portion is a twofold unit where wire of the gem clip is folded with a sharp curve thereby tightening the bookmarker string therein.

10. A removable bookmarker as defined in claim 7, wherein the tightening portion is a twofold unit where wire of the gem clip is folded with a sharp curve and further curved to form a coil spring thereby tightening the bookmarker string therein.

11. A removable bookmarker as defined in claim 1, wherein a T-shaped unit attached to or formed on the bookmarker string is inserted in a hole of an oblong card.

12. A removable bookmarker as defined in claim 6, wherein a T-shaped unit attached to or formed on the bookmarker string is inserted in a hole of an oblong card.

13. A bookmarker string for use with a bookmarker for marking a page of a book, wherein at least one string is connected in a detachable way to a top of an attachment member consisting of either a hairpin clip or gem clip.

14. A bookmarker string as defined in claim 13, wherein at least one of a plurality of strings is about twice as long as the other strings and tied at the top of the attachment member.

15. A bookmarker string as defined in claim 13, wherein one string is longer than other strings and its center is marked to be connected to the attachment member.
